(19) United States
(12) Patent Application Publication
(10) Pub. No.: US 2022/0325367 A1
(43) Pub. Date: Oct. 13, 2022

(54) SKIP HOIST OF A BLAST FURNACE

(71) Applicant: PAUL WURTH S.A., Luxembourg (LU)

(72) Inventors: Patrick HUTMACHER, Bettembourg (LU); Charles STEICHEN, Ettelbruck (LU); Joe MUNHOVEN, Hettermillen (LU)

(21) Appl. No.: 17/639,415

(22) PCT Filed: Sep. 7, 2020
(86) PCT No.: PCT/EP2020/074976

§ 371 Date: Mar. 1, 2022

(30) Foreign Application Priority Data
Sep. 9, 2019 (LU) LU101382

(51) Int. Cl. C21B 7/18; B66B 9/06; B66B 11/06; B66D 1/12; B66D 1/22; F27B 1/20

(52) U.S. Cl. CPC C21B 7/18; B66B 9/06; B66B 11/06; B66D 1/12; B66D 1/22; F27B 1/20

(57) ABSTRACT

A skip hoist of a blast furnace includes a winch system. In order to provide an improved drive system for a skip hoist of a blast furnace, the winch system includes
a winch drum, rotatably mounted about a drum axis;
at least three drive motors; and
a transmission for transferring a drive force from each of the drive motors to the winch drum.

The skip hoist further relates to a blast furnace.

### TECHNICAL FIELD

The disclosure relates to a skip hoist of a blast furnace and to a blast furnace.

### BACKGROUND

Blast furnace plants commonly employ a skip hoist system in order to charge materials like iron ore and coke to the top of the blast furnace. Commonly, these systems comprise a pair of skip cars, which run on adjacent inclined tracks leading from ground level to the top of the furnace. These skip cars are interconnected by a cable, which is movable by a skip winch. As one filled car ascends the tracks, the other empty car descends, thereby partially balancing the weight of the filled car.

According to a common design, a current skip winch system comprises a winch drum (typically being 2-3 m in diameter), which is connected via a coupling and an additional break to a custom-built gearbox. The gearbox is powered by two electric motors, typically having a power of 750 kW and operating at 690 V (750 rpm; 6 poles). For each motor, the system comprises a VVVF (variable voltage variable frequency drive). In contrast to a more commonly available 400 V supply, the 690 V supply necessitates a dedicated transformer for the motors of the skip hoist system. Also, an additional brake is needed at each motor to ensure that the winch drum can be securely stopped and held. Design and construction of the gearbox are expensive. In case of failure of the gearbox, the skip hoist needs to be shut down as an operation is no longer possible until replacement or maintenance is finished. All components are mounted separately and independently on one support structure, wherefore the components need to be aligned manually. This on-site work consumes a lot of time as a precise execution is crucial for a proper operation.

The nominal operation power of such a current system that is needed to run on 100% is approximately 1000 kW. As the two installed 750 kW electric motors deliver an overall power of 1500 kW, the system has an unused back-up of 500 kW or 50%, which can be considered as a waste of resources. In case of a motor failure, on the other hand, one of the two 750 kW motors is not in operation and the system only has 750 kW of power at its disposal. In other words, the skip hoist system is only operable at 75%. This in turn affects the material feed to the blast furnace and results in a severe loss of productivity. For security reasons, a “back-up” VVVF is often installed (leading to a total of three VVVF) and a spare 750 kW motor is stored on site in order to minimize production losses. This spare motor is large and consumes a lot of storage space. In general, the 750 kW motors have a high weight and are expensive, making any replacement expensive and difficult. Lead time of spare motor and VVVF are very high compared to more standardized systems.

CN 106517012 A discloses a hydraulic wireline winch for a drilling rig, with a support and brake assemblies. The support includes a box assembly as well as two gear box casings and two end-cap assemblies disposed on opposite ends of the box assembly. Two groups of brake assemblies are symmetrically set on the two ends of the casing. Each brake assembly comprises a drive mechanism, a reducing gear and brake mechanism. The drive mechanism is arranged on the end-cap assembly while the reducing gear is arranged in the gear box casing. The drive mechanisms are circumferentially disposed around an axis of a cylinder for a winch cable and drive the cylinder via the reducing gear.

EP 2 280 191 A2 discloses a drive unit for driving a ring gear. The drive unit comprises a motor, a gearbox and an output shaft on which a pinion for driving the ring gear is arranged. The drive unit also has a mechanical overload protection arranged between the gearbox and the pinion. A plurality of drive units may be arranged to collectively drive the ring gear.

CN 101343024 A discloses a lifting mechanism of a crane for a coke pot. It comprises four reel groups, each of which is driven by an electrical motor via a planetary reduction gear and a coupler. A cable is wound on each reel group and runs over a loose pulley and a fixed pulley. The coke pot can be suspended on the four loose pulleys. The electric motors and their output shafts are symmetrically disposed with respect to the reduction gear.

### SUMMARY

The present disclosure provides an improved drive system for a skip hoist of a blast furnace. This object is solved by a skip hoist according to claim 1 and by a blast furnace according to claim 15.

The disclosure provides a skip hoist of a blast furnace with a winch system. It is understood that the skip hoist is used to transport materials like iron ore and coke to the top of the blast furnace. It comprises at least one inclined track for a skip car that is connected to a cable, which cable is operated by a winch system. Commonly, the skip hoist comprises a pair of skip cars which run on adjacent tracks and are interconnected by the cable, so that by operation of the winch system, one skip car is moved upwards while the other is moved downwards. A typical lifting capacity of the skip hoist may be between 20 t and 60 t or between 30 t and 50 t. A typical lifting height may be between 60 m and 100 m or between 80 m and 100 m. A typical duration of one lifting operation may be between 30 s and 80 s or between 40 s and 60 s. In other words, the skip hoist is normally required to lift a high load to a great height in a short time.

The winch system comprises a winch drum, which is rotatably mounted about a drum axis. The winch drum is adapted to receive the above-mentioned cable, i.e. in operational state, the cable is at least partially wound around the winch drum. The winch drum is mounted so that it is rotatable about the drum axis, which normally is a symmetry axis of the winch drum. The size and design of the winch drum as such may be identical or similar to winch systems that are known in the art. For instance, it may have a diameter between 2 and 3 meters and an axial length (measured along the drum axis) between 2 and 5 meters.

The winch system further comprises at least three drive motors. Although it would be conceivable that the drive motors could be combustion motors, they are usually electric motors. Generally, the drive motors are rotation motors with a rotor adapted to rotate with respect to a stator. Preferably, these are standard motors that are easily available, e.g. having 4 poles, a rotation speed of 1500 rpm and an operating voltage of 400 V. The nominal driving moment of the individual motor may be between 1000 Nm and 1500 Nm or between 1100 Nm and 1400 Nm, while the maximum driving moment may be between 2500 Nm and 3200 Nm or between 2700 Nm and 3000 Nm. Preferably, all drive motors are identical. Although this is not essential for the disclosure, it facilitates maintenance and replacement of a drive motor.

Furthermore, the winch system comprises a transmission for transferring a drive force from each of the drive motors to the winch drum. The transmission generally can comprise any element adapted for transferring the drive force, e.g. shafts, gears and the like. Generally, the transmission has a gear ratio so that the drive force is not only transferred but increased while the rotation speed of the winch drum is reduced with respect to the rotation speed of the drive motors. As will be explained below, the transmission (or at least a part of it) is normally disposed in at least one casing or housing that protects the moving parts from dirt and mechanical damage.

According to the inventive concept, the at least three drive motors are coupled by the transmission to the winch drum. Thus, the power needed from the individual drive motor is comparatively low. This means that smaller and “more standardized” motors can be used. Such motors usually operate at a lower voltage (e.g. 400 V) so that a dedicated transformer is not necessary. Also, the drive force that needs to be transferred by the transmission from each individual drive motor is considerably lower than with e.g. two more powerful motors. Thus, the load on the transmission, e.g. on meshing teeth of interfacing gears, is reduced. Furthermore, the inertia of the inventive winch system is usually lower compared to the inertia of a system with two big motors and a big gearbox, wherefore the power consumption during acceleration is usually smaller. Also, it is often unnecessary to employ an additional brake, i.e. the standard brake of the respective drive motor is sufficient.

Another advantage is that the power contribution of a single drive motor is smaller in relation to the total power output of all motors. Therefore, failure of a single motor has less impact on the operability of the winch system. In order to guarantee full operability in case of two motors, the combined power of both motors would need to be 200% of the nominal power, which would be highly uneconomical. On the other hand, if the combined power is equal to or just above the nominal power, a failure of a single motor renders the skip hoist inoperable. With a higher number of drive motors, the combined power can be selected to be not too much above the nominal power, while still maintaining a sufficient percentage of the nominal power if a single drive motor fails.

As explained, the winch system has a nominal power that is necessary for optimum operation of the skip hoist. In other words, the nominal power represents the power that is sufficient to maintain optimum, unimpaired operation of the skip hoist. The nominal power depends on the requirements of the blast furnace, but is normally between 600 kW and 1500 kW or between 800 kW and 1200 kW. For instance, the nominal power could be 1000 kW. According to a preferred embodiment, the drive motors have individual power outputs selected so that in case of a failure of one drive motor, the combined power output of the other drive motors is at least 100% of the nominal power. The individual power output is the (maximum) power output for which a single drive motor is designed. This individual power output may be between 100 kW and 400 kW or between 150 kW and 250 kW. The combined power output is the sum of the individual power outputs of the remaining drive motors when one drive motor fails. Failure in this context refers to the respective drive motor becoming unable to provide any drive force. This may be due to a failure of the motor itself, a failure of a VVVF assigned to this motor or a failure of a part of the transmission that is designed to transfer a drive force from this specific motor to the winch drum. In case of such a failure, the individual power outputs of the remaining drive motors are sufficient to provide at least 100% of the nominal power. In other words, if one drive motor fails, the nominal power can be fully maintained so that operation of the skip hoist and the blast furnace can continue even while the non-operational drive motor is removed to be replaced by a new drive motor. A temporary shutdown of the winch system may be necessary for some stages of the replacement process, but these can be relatively short and do not significantly impair the operation of the blast furnace. In this context, the relatively increased number of drive motors also reduces the unused backup. For instance, if the system comprises N identical drive motors and N−1 drive motors are sufficient to provide 100% of the nominal power, the unused backup provided by the Nth drive motor is

$$\frac{100 \%}{N - 1}$$

of the nominal power.

It is also conceivable that the winch system is permanently adapted to lower or higher requirements for the nominal power. For instance, in a blast furnace installation that requires less nominal power, the winch system can be adapted by reducing the number of drive motors and optionally adapting the transmission. In some cases, the adaptation of the transmission may be minimal or even unnecessary, so that it is sufficient to simply omit one or several drive motors.

In order to further improve the above-mentioned beneficial effects, it is preferred that the winch system comprises at least four drive motors, preferably at least five drive motors, more preferably at least six drive motors. By way of example, the winch system could comprise six 200 kW drive motors for a skip hoist having a nominal power of 1000 kW. The combined power output would be 1200 kW (120% of the nominal power). If one of the drive motors fails, the skip hoist could still be operated at 100% effectiveness—and therefore the blast furnace could be operated with 100% production rate.

While it is desirable to maintain at least 100% of the nominal power even if one drive motor fails, it would be uneconomical to exceed this percentage significantly, since this would inevitably increase the unused backup power. Therefore, it is preferred that the individual power outputs are selected so that in case of a failure of one drive motor, the combined power output of the other drive motors is at maximum 110% of the nominal power. Preferably, this could be at maximum 105% or 100%.

Preferably, the transmission comprises a main gear that is connected to the winch drum and rotatable about the drum axis, and a plurality of drive gears circumferentially arranged about the main gear and adapted to interface with the main gear, wherein each drive gear is coupled to a drive motor. In other words, the drive force is transferred from each drive motor to a drive gear, which may be coupled directly or indirectly to this drive motor. Then, the drive force is transferred from the drive gears to the main gear that is connected to the winch drum. The drive gears (the number of which corresponds to the number of drive motors) are arranged circumferentially about the main gear. One could also say that they are arranged along an outer periphery of the main gear. The main gear can also be regarded as a center gear. With the drum axis representing the axial direction, the drive gears are all offset radially from the drum axis. Also, they are tangentially offset with respect to each other. In some embodiments, they may be evenly spaced along the tangential direction, while in other embodiments, different offsets or spacings are possible. In general, the concept with one (central) main gear and a plurality of drive gears disposed circumferentially about the main gear allows for a compact design of the transmission as a whole, thus leading to cost reductions. In this embodiment, the winch system can be adapted easily to different numbers of drive motors. For each additional drive motor, an additional drive gear can be added without making greater changes to the overall design of the transmission.

The main gear could e.g. be conical or the like. It could have inner teeth, i.e. teeth that are facing radially inwards with respect to the drum axis or teeth that are facing in the direction of the drum axis (like in a crown gear). However, such configurations may necessitate a more complicated arrangement of the drive motors. Therefore, the main gear is preferably a cylindrical gear with outer teeth. In other words, the main gear has a cylindrical shape, e.g. in contrast to a conical shape. In particular, it may have an annular shape with the center of the main gear being hollow. Furthermore, it has outer teeth, i.e. teeth or a serration that faces radially outwards with respect to the drum axis. In particular, the main gear may be a spur gear.

Within the scope of the disclosure, there are a variety of possibilities how the drive gears could interface with the main gear. For instance, the drive gears could be conical and rotate about an axis that is inclined with respect to the drum axis. The drive gears could even be worms interacting with a main gear that is designed as a worm wheel, in which case the rotation axis of the worm could be perpendicular to the drum axis. It is preferred, though, that least one drive gear is rotatable about a gear axis that is parallel to the drum axis. It is further preferred that every drive gear is rotatable about a gear axis that is parallel to the drum axis. It is understood that each drive gear has its own gear axis, i.e. this embodiment corresponds to a plurality of gear axes that are parallel to the drum axis.

It is possible that a drive motor is directly connected to its drive gear, i.e. that the drive gear is directly coupled to the rotor of the respective drive motor. Normally, though, at least one drive motor is connected to a drive gear by a drive transmission. In particular, every drive motor may be connected to its drive gear by a drive transmission. One function of the drive transmission may be to reduce the rotation speed of the drive gear with respect to the drive motor. However, it could also have other functions like enabling a transition between a rotation axis of the drive motor and the gear axis of the drive gear if these axes are not parallel. Mostly, the drive transmission is rather simple and can be referred to as a gearbox. According to this embodiment, the entire transmission consists of the main gear, the drive gears and the corresponding drive transmissions. These drive transmissions can be standard gearboxes, in contrast to the customized, large gearbox according to prior art. This leads to additional cost savings. The drive motor, the drive transmission and the drive gear may be referred to as part of a drive assembly.

Normally, at least one drive motor (or every drive motor) is arranged parallel to the drum axis. In other words, the rotation axis of the rotor of the respective motor is parallel to the drum axis. This may in particular be combined with the above-mentioned embodiment in which the gear axes are parallel to the drum axis.

Normally, most parts or all parts of the transmission need to be disposed in some kind of housing or casing. According to a preferred embodiment, the main gear and the drive gears are at least partially disposed in a main casing and each drive transmission is disposed in a drive casing. In other words, while the main gear and the drive gears are disposed in a main casing (or housing), there is a single, dedicated drive casing (or housing) for each drive transmission. Each drive casing is produced separately from the main casing. Like each drive transmission may be a standard gearbox, the drive casing may also be a standard component.

As mentioned above, the drive motor and the drive transmission may be parts of a drive assembly. Accordingly, the drive motor may be mounted to the drive casing to be at least partially supported by the drive casing. The connection may be a non-permanent connection e.g. by bolts. A support structure for the drive motor may also be connected to the drive casing. If the drive motor or the drive transmission need to be replaced, both elements can be assembled together as part of the drive assembly before they are installed to the winch system. Therefore, no separate alignment of these two components is necessary. This embodiment also facilitates adaptation of the winch system to different nominal powers. The drive assembly is a module that can be integrated easily into different winch systems, wherein the number of modules is selected depending on the required nominal power.

Preferably, the drive gear is connected to the drive casing and is adapted to be removed from the main gear together with the drive casing. This corresponds to the above-mentioned concept of the drive gear and the drive transmission being part of a drive assembly. It is understood that the drive gear is connected to the drive transmission, which in turn is disposed inside the drive casing and movably connected thereto. If the drive gear is adapted to be removed from the main gear together with the drive casing, this greatly facilitates installation and replacement of these components. They can be assembled together as part of the drive assembly before they are installed to the winch system. Therefore, no separate alignment of the drive gear and the drive casing (or the drive transmission, respectively) is necessary.

It is highly preferred that the drive casing is connected to and at least partially supported by the main casing. The connection is normally a non-permanent connection e.g. by bolts. Thus, since the drive casing is directly connected to the main casing, proper alignment of the drive transmission (and possibly the drive gear) with respect to the main gear can be facilitated. If the drive gear and the drive motor are connected to the drive casing as described above, all components can be aligned properly by connecting the drive casing to the main casing. The main casing may be connected to a base or support structure of the entire winch system. It will be appreciated that this embodiment further facilitates adaptation to different requirements of nominal power. The only adaptation necessary may pertain to the main casing and possibly to the main gear. A suitable number of “standardized” drive casings can be connected to the respective main casing, depending on the power requirements of the respective skip hoist and blast furnace.

In particular, the drive casing may be connected to the main casing by a connecting flange mounted circumferentially around an access opening of the main casing, which access opening has a cross section larger than a cross section of the drive gear. The connecting flange can be a portion of the drive casing or it may be fixedly connected to the drive casing. It is mounted circumferentially around an access opening in the main casing. The access opening is designed to allow for insertion of the drive gear into (or removal out of) the main casing without the need of further dismantling the main casing. Therefore, the cross-section of the access opening is larger than the cross-section of the drive gear. For instance, if the drive gear is a cylindrical gear, the access opening may be circular with a diameter larger than the diameter of the drive gear.

The disclosure further provides a blast furnace. The blast furnace comprises a furnace shaft (or furnace proper), where raw materials like iron ore and coke are subjected to high temperatures and undergo chemical reactions which normally result in producing pig iron from the iron ore. The blast furnace further comprises a top charging installation at the top of the blast furnace, for charging raw material to the furnace shaft. This charging installation may preferably be a bell-less charging installation. It is normally disposed above the furnace shaft so that raw materials can be charged to the furnace shaft by gravity. Further, the blast furnace comprises an inventive skip hoist, with a winch system that comprises a winch drum, mounted to be rotatable about a drum axis, at least three drive motors, and a transmission for transferring a drive force from each of the drive motors to the winch drum. All these terms have been explained above with respect to the inventive skip hoist and will therefore not be explained again. The skip hoist also comprises at least one inclined track for a skip car, the at least one track leading from ground level to the top of the furnace (at the level of the top charging installation), the at least one skip car being connected to a cable that is operated by the winch system (arranged at the level of the top charging installation), and being adapted for transporting raw material from ground level to the top of the blast furnace and charging the raw material to the top charging installation. As explained above, the skip hoist normally comprises two adjacent tracks for two skip cars which are interconnected by the cable, so that by operation of the winch system, one skip car is moved upwards while the other is moved downwards. Preferred embodiments of the inventive blast furnace correspond to those of the inventive skip hoist.

### BRIEF DESCRIPTION OF THE DRAWINGS

Preferred embodiments of the disclosure will now be described, by way of example, with reference to the accompanying drawings, in which:

FIG. 1 is a perspective view of winch system for an inventive skip hoist;

FIG. 2 is a perspective view of the winch system from FIG. 1 with some elements removed;

FIG. 3 is a perspective view of a drive assembly of the winch system from FIG. 1; and

FIG. 4 is a sectional view of a portion of the winch system from FIG. 1.;

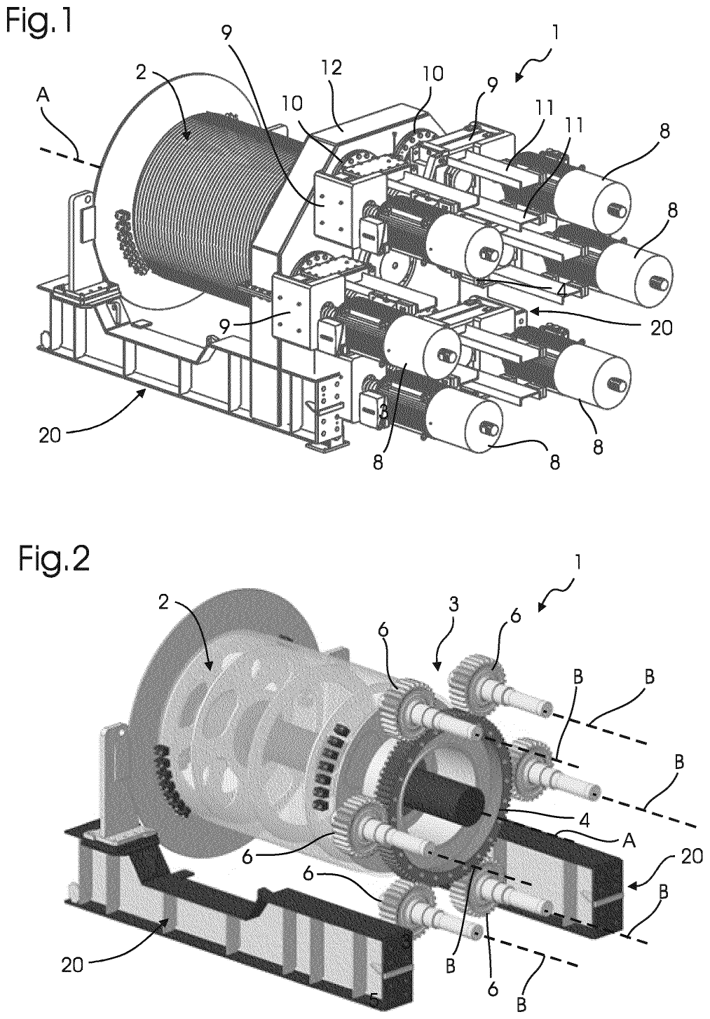

Throughout FIGS. 1 to 4, similar or identical elements are identified by identical reference signs.

### DETAILED DESCRIPTION OF THE DRAWINGS

FIGS. 1 to 4 show an winch system 1 for an inventive skip hoist of an inventive blast furnace. In this example, the lifting capacity of the skip hoist is 39-45.5 t, the lifting height is 96 m and the duration of one lifting operation is 40-60 s.

The winch system 1 comprises a winch drum 2 that is rotatably mounted about a drum axis A with respect to a stationary base 20. In operational state, the winch drum 2 receives a cable (not shown) for moving one or normally two skip cars of the skip hoist. The winch drum 2 is driven by six drive motors 8 that are aligned parallel to the drum axis A. For instance, each drive motor 8 can be a 200 kW motor with 4 poles, operating at 1500 rpm and 400 V and having a nominal driving moment of 1282 Nm and a maximum driving moment of 2820 Nm. The drive force from the individual drive motors 8 is transferred to the winch drum via a transmission 3. The transmission comprises a main gear 4 that is fixedly connected to the winch drum 2 and therefore rotatable about the drum axis A. The main gear 4 is designed as a spur gear with a hollow center. Six drive gears 6 are disposed around the circumference of the main gear 4. Each drive gear 6 is a spur gear having outer teeth that are meshing with the teeth of the main gear 4 and is rotatable about a gear axis B. All of the gear axes B are parallel to the drum axis A. Since the total drive force necessary for operating the winch drum 2 is divided among a total of six drive motors 6, the load on the teeth of the drive gears 6 and the main gear 4 is only low to moderate, thus increasing the life time of the winch system 1.

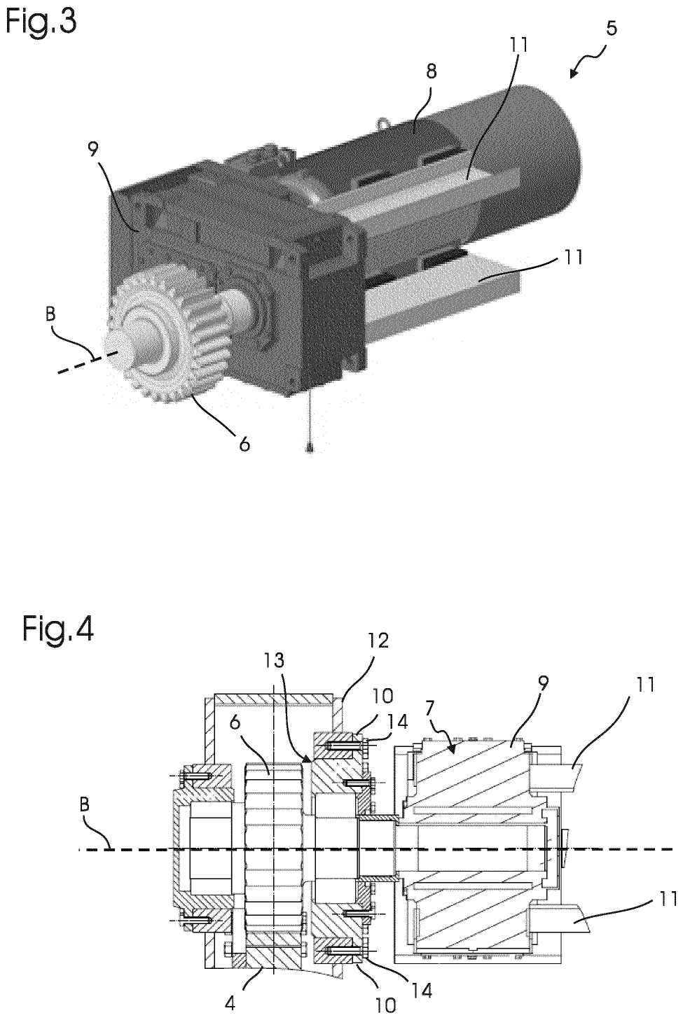

The main gear 4 and the drive gears 6 are disposed in a main casing 12 that has been removed in FIG. 2, along with other components of the winch system 1. Each drive gear 6 is part of a drive assembly 5 that is shown in FIG. 3. Apart from the drive gear 6, the drive assembly 5 comprises a drive casing 9 that houses a drive transmission 7, and one drive motor 8. The drive motor 8 is connected to and at least partially supported by the drive casing 9. This connection is partially established by two support beams 11 that extend parallel to the gear axis B. The drive assembly 5 is designed to be installed into or removed from the winch system 1 as a whole. In other words, the drive motor 8 is connected and aligned to the drive casing 9 before the entire drive assembly 5 is connected on-site to the winch system 1, or more specifically, to the main casing 12. Likewise, the drive gear 6 is connected to the drive transmission 7 and to the drive casing 9 before the entire drive assembly 5 is installed to the winch system 1. Therefore, all components of the drive assembly 5 can be aligned off-site, which greatly facilitates installation and replacement. The drive casing 9 is connected to the main casing 12 by a connecting flange 10 that is disposed circumferentially around a circular access opening 13 in the main casing 12. The connecting flange 10 is connected to the main casing 12 by a plurality of bolts 14. In order to remove the drive assembly 5 from the main casing 12, the bolts 14 are unscrewed and the drive assembly 5, including the drive gear 6 can be removed in the direction of the gear axis B. In order to facilitate this process, a cross-section of the access opening 13 is bigger than a cross-section of the drive gear 6, wherefore the drive gear 6 can be moved out of the main casing 12 through the access opening 13.

The individual power outputs and the number of the drive motors 8 is selected so that repair or replacement of a drive assembly 5 can be carried out without any longer shutdown of the winch system 1 or reduction of the operability of the blast furnace. By way of example, the winch system 1 has a nominal power of 1000 kW. This power is necessary for normal, optimum operation of the skip hoist. With all six drive motors 8 operating, the total power output is 1200 kW. Thus, there is an unused backup of 200 kW, which is moderate and thus not uneconomical. However, if one of the drive motors 8 fails and the drive assembly 5 of this drive motor 8 is removed from the winch system 1, the remaining five drive motors 8 still have a combined power output of 1000 kW, corresponding to 100% of the nominal power. Therefore, operation of the skip hoist only needs to be interrupted shortly for removing the drive assembly 5 and later on for reinstalling the drive assembly 5 (or a replacement drive assembly 5). Since all components of the drive assembly 5 have been connected and aligned with respect to each other off-site, the necessary time for installation is also reduced.

The winch system 1 can be adapted easily to a different nominal power. For instance, for a skip hoist with a nominal power of 800 kW, one drive motor 8 and its drive assembly 5 can be omitted, while the rest of the winch system 1 can remain largely unchanged. In the simplest case, the necessary adaptation would be to close the corresponding access opening 13. For a skip hoist with a nominal power of 1400 kW, two additional drive assemblies 5 can be added, which may only necessitate redesigning the main casing 12 to have eight access openings 13 that allow for installation of eight drive assemblies 5. However, no redesign of the drive assembly is necessary.

1. A skip hoist of a blast furnace, with a winch system that comprises:
a winch drum, rotatably mounted about a drum axis (A);
at least three drive motors; and
a transmission configured for transferring a drive force from each of the drive motors to the winch drum.

2. The skip hoist according to claim 1, wherein the winch system has a nominal power configured, for optimum operation of the skip hoist, and the drive motors have individual power outputs selected wherein in case of a failure of one drive motor, the combined power output of the other drive motors is at least 100% of the nominal power.

3. The skip hoist according to claim 2, comprising at least four drive motors.

4. The skip hoist according to claim 2, wherein in case of a failure of one drive motor, the combined power output of the other drive motors is at maximum 110% of the nominal power.

5. The skip hoist according to claim 1, wherein the transmission comprises a main gear that is connected to the winch drum and rotatable about the drum axis, and a plurality of drive gears circumferentially arranged about the main gear and adapted to interface with the main gear, wherein each drive gear is coupled to a drive motor.

6. The skip hoist according to claim 5, wherein the main gear is a cylindrical gear with outer teeth.

7. The skip hoist according to claim 5, wherein at least one drive gear is rotatable about a gear axis that is parallel to the drum axis.

8. The skip hoist according to claim 7, wherein at least one drive gear is a cylindrical gear with outer teeth.

9. The skip hoist according to claim 5, wherein at least one drive motor is connected to a drive gear by a drive transmission.

10. The skip hoist according to claim 9, wherein the main gear and the drive gears are at least partially disposed in a main casing and each drive transmission is disposed in a drive casing.

11. The skip hoist according to claim 10, wherein the drive motor is mounted to the drive casing to be at least partially supported by the drive casing.

12. The skip hoist according to claim 11, wherein the drive gear is connected to the drive casing and is adapted to be removed from the main gear together with the drive casing.

13. The skip hoist according to claim 12, wherein the drive casing is connected to and at least partially supported by the main casing.

14. The skip hoist according to claim 13, wherein the drive casing is connected to the main casing by a connecting flange mounted circumferentially around an access opening of the main casing, which access opening has a cross section larger than a cross section of the drive gear.

15. A blast furnace comprising:
a furnace shaft;
a top charging installation at the top of the blast furnace, for charging raw material to the furnace shaft; and
a skip hoist according to claim 1, comprising at least one inclined track for a skip car, the at least one track leading from ground level to the top of the furnace, the at least one skip car being connected to a cable that is operated by the winch system, and being adapted for transporting raw material from ground level to the top of the blast furnace and charging the raw material to the top charging installation.

16. The skip hoist according to claim 2, comprising at least five drive motors, more preferably at least six drive motors.

17. The skip hoist according to claim 2, comprising at least six drive motors.
